(19) United States
(12) Patent Application Publication
(10) Pub. No.: US 2005/0284340 A1
(43) Pub. Date: Dec. 29, 2005

(54) Providing freezing and thawing resistance to cementitious compositions

(76) Inventors: Thomas M. Vickers JR., Concord Township, OH (US); Frank T. Gay, Twinsburg, OH (US); Bruce J. Christensen, Shanghai (CN)

Correspondence Address: JOSEPH G CURATOLO, ESQ.;CURATOLO SIDOTI CO. LPA, 24500 CENTER RIDGE ROAD, SUITE 280, CLEVELAND, OH, 44145, US

(21) Appl. No.: 11/152,006

(22) Filed: Jun. 14, 2005

Related U.S. Application Data
(60) Provisional application No. 60/579,692, filed on Jun. 15, 2004.

(51) Int. Cl. C04B 16/00

(52) U.S. Cl. 106/802

(57) ABSTRACT

An improved freeze-thaw durability wet cast cementitious composition is provided that uses microspheres that are blended directly into the wet cast cementitious composition. The microspheres provide voids in the wet cast cementitious composition material matrix, and such voids act to increase freeze-thaw durability of the cured and hardened cementitious material.

### CROSS REFERENCE TO RELATED APPLICATIONS

This application claims the benefit of the filing date of U.S. Provisional Application for Patent Ser. No. 60/579,692 filed Jun. 15, 2004.

### BACKGROUND

It is well known that freezing and thawing cycles can be extremely damaging to water-saturated hardened cement compositions such as concrete. The best known technique to prevent or reduce the damage done is the incorporation in the composition of microscopically fine pores or voids. The pores or voids function as internal expansion chambers and can therefore protect the concrete from frost damage by relieving the hydraulic pressure caused by an advancing freezing front in the concrete. The method used in the prior art for artificially producing such voids in concrete has been by means of air-entraining agents, which stabilize tiny bubbles of air that are entrapped in the concrete during mixing.

These air voids are typically stabilized by use of surfactants during the mixing process of wet cast concrete. Unfortunately, this approach of entraining air voids in concrete is plagued by a number of production and placement issues, some of which are the following:

Air Content—Changes in air content of the cementitious mixture can result in concrete with poor resistance to freezing and thawing distress if the air content drops with time or reduce the compressive strength of concrete if the air content increases with time. Examples are pumping concrete (decrease air content by compression), job-site addition of a superplasticizer (often elevates air content or destabilizes the air void system), interaction of specific admixtures with the air-entraining surfactant (could increase or decrease air content).

Air Void Stabilization—The inability to stabilize air bubbles can be due to the presence of materials that adsorb the stabilizing surfactant, i.e., flyash with high surface area carbon or insufficient water for the surfactant to work properly, i.e, low slump concrete.

Air Void Characteristics—Formation of bubbles that are too large to provide resistance to freezing and thawing, can be the result of poor quality or poorly graded aggregates, use of other admixtures that destabilize the bubbles, etc. Such voids are often unstable and tend to float to the surface of the fresh concrete.

Overfinishing—Removal of air by overfinishing, removes air from the surface of the concrete, typically resulting in distress by scaling of the detrained zone of cement paste adjacent to the overfinished surface.

The generation and stabilization of air at the time of mixing and ensuring it remains at the appropriate amount and air void size until the concrete hardens are the largest day-to-day challenges for the ready mix concrete producer in North America.

Adequately air-entrained concrete remains one of the most difficult types of concrete to make. The air content and the characteristics of the air void system entrained into the concrete cannot be controlled by direct quantitative means, but only indirectly through the amount/type of air-entraining agent added to the mixture. Factors such as the composition and particle shape of the aggregates, the type and quantity of cement in the mix, the consistency of the concrete, the type of mixer used, the mixing time, and the temperature all influence the performance of the air-entraining agent. The void size distribution in ordinary air-entrained concrete can show a very wide range of variation, between 10 and 3,000 micrometers (μm) or more. In such concrete, besides the small voids which are essential to cyclic freeze-thaw resistance, the presence of larger voids—which contribute little to the durability of the concrete and could reduce the strength of the concrete—has to be accepted as an unavoidable feature

The characteristics of an air void system in hardened concrete are determined by means of ASTM C457 Standard Test method for Microscopical Determination of Parameters of the Air-Void System in Hardened concrete. These characteristics are expressed as a series of parameters that are indicative of the average voids size (specific surface area), volumetric abundance (air content) and average distance between the voids (spacing factor). These values have been used in the concrete industry to determine the expected performance and durability of concrete in a water-saturated cyclic freezing environment. ACI guidelines recommend that the specific area be greater than 600 in⁻¹ and the spacing factor equal to or less than 0.008 in to ensure resistance to freezing and thawing cycles.

Those skilled in the art have learned to control for these influences by the application of appropriate rules for making air-entrained concrete. They do, however, require the exercise of particular care in making such concrete and continually, checking the air content, because if the air content is too low, the frost resistance of the concrete will be inadequate, while on the other hand, if the air content is too high it will adversely affect the compressive strength.

The methods for controlling air voids in the prior art often result in inconsistent performance. If air bubbles of acceptable size and spacing are not entrained by the action of mixing, then no amount of bubble stabilizing chemical systems can produce an acceptable air void structure in the hardened concrete.

Therefore, it is desirable to provide an admixture which produces a freeze-thaw durable void structure directly in a wet cast cementitious mixture, without requiring the shear conditions for generation of properly sized air bubbles during mixing. The void structures may comprise optimally sized voids to the wet cast mixture that provide the cementitious composition with improved freeze-thaw durability. The admixture should also reduce or eliminate the reduction of compressive strength for products manufactured from wet cast mixtures containing conventional air-entraining chemical admixtures.

### SUMMARY

A cementitious freeze-thaw damage resistant wet cast composition is provided that comprises hydraulic cement and polymeric microspheres, wherein the polymeric microspheres have an average diameter of about 0.1 μm to less than about 10 μm, and the polymeric microspheres are liquid filled.

A method for preparing a freeze-thaw damage resistant wet cast cementitious composition is provided that comprises forming a mixture of water, hydraulic cement, and polymeric microspheres, wherein the polymeric microspheres have an average diameter of about 0.1 μm to about 10 μm, and the polymeric microspheres are liquid filled.

### DETAILED DESCRIPTION

An improved freeze-thaw durability wet cast cementitious composition is provided. The composition uses very small (less than 10 μm) liquid filled (unexpanded) polymeric microspheres that are blended directly into the cementitious composition. The polymeric microspheres are produced and marketed under a variety of trade names and use a variety of materials to form the wall of the particle.

The use of polymeric microspheres substantially eliminates some of the practical problems encountered in the current art. It also makes it possible to use some materials, i.e., low grade, high-carbon fly ash, which are currently landfilled as they are not currently considered usable in air-entrained cementitious compositions without further treatment. This results in cement savings, and therefore economic savings. As the voids “created” by this approach are much smaller than those obtained by conventional Air Entraining Agents (AEAs), the volume of polymeric microspheres that is required to achieve the desired durability is also much lower (less than about 4 volume percent versus typically 5-6 percent) than in conventional air entrained cementitious compositions. Therefore, a higher compressive strength can be achieved with the new method at the same level of protection to freezing and thawing. Consequently, the most expensive component used to achieve strength, i.e., cement, can be saved.

The cementitious composition uses the addition of polymeric microspheres to provide void spaces in the cementitious material matrix prior to final setting, and such void spaces act to increase the freeze-thaw durability of the cementitious material. Polymeric microspheres introduce voids into the cementitious mixture to produce a fully formed void structure in the cementitious composition that resists concrete degradation produced by water-saturated cyclic freezing and does not rely on air bubble stabilization during mixing of the cementitious composition. The freeze-thaw durability enhancement produced with the polymeric microspheres is based on a physical mechanism for relieving stresses produced when water freezes in a cementitious material. In conventional practice, properly sized and spaced voids are generated in the hardened material by using chemical admixtures to stabilize the air voids entrained into a cementitious composition during mixing. In conventional cementitious compositions these chemical admixtures as a class are called air entraining agents. This composition uses polymeric microspheres to form a void structure and does not require the production and/or stabilization of air entrained during the mixing process.

The cementitious wet cast compositions provided generally comprise hydraulic cement, and polymeric microspheres. Water is added to form the cementitious mixture into a paste. The cementitious wet cast compositions include poured cement compositions and articles formed from cementitious compositions.

The hydraulic cement can be a portland cement, a calcium aluminate cement, a magnesium phosphate cement, a magnesium potassium phosphate cement, calcium sulfoaluminate cement or any other suitable hydraulic binder. Aggregate may be included in the cementitious wet cast mixture. The aggregate can be silica, quartz, sand, crushed marble, glass spheres, granite, limestone, calcite, feldspar, alluvial sands, any other durable aggregate, and mixtures thereof.

It has been found that an average sphere size of a diameter of less than 10 μm can produce favorable results with higher microsphere survivability after mixing than use of larger microspheres. The polymeric microspheres have a hollow core and compressible wall. Expanded polymeric microspheres (formed by expansion of a self contained liquid to gas phase) or unexpanded polymeric microspheres (contain unexpanded liquid state) may be used. The interior portion of the polymeric microspheres comprises a void cavity or cavities that may contain gas (gas filled) as in expanded polymeric microspheres or liquid (liquid filled) such as in unexpanded polymeric microspheres.

The polymeric microspheres may be comprised of a polymer that is at least one of polyethylene, polypropylene, polymethyl methacrylate, poly-o-chlorostyrene, polyvinyl chloride, polyvinylidene chloride, polyacrylonitrile, polymethacrylonitrile, polystyrene, and copolymers thereof, such as copolymers of vinylidene chloride-acrylonitrile, polyacrylonitrile-copolymethacrylonitrile, polyvinylidene chloride-copolyacrylonitrile, or vinyl chloride-vinylidene chloride, and the like. As the polymeric microspheres are composed of polymers, the wall is flexible, such that it moves in response to pressure. This is in comparison to glass, ceramic or other inflexible materials which produce microspheres with rigid structures that fracture when exposed to pressure. The material from which the microspheres are to be made, therefore, is flexible, yet resistant to the alkaline environment of cementitious compositions.

The smaller the diameter of the polymeric microspheres, the less that is required to achieve the desired spacing factor (which is a predictor of resistance to freezing and thawing). This is beneficial from a performance perspective, in that higher compressive strength may occur, as well as an economic perspective, since a less mass of polymeric microspheres is required. Similarly, the wall thickness of the polymeric microspheres should be as thin as possible, to minimize material cost, but thick enough to resist damage/fracture during the cementitious composition mixing, placing, consolidating and finishing processes.

The amount of polymeric microspheres to be added to the cementitious composition mixture is about 0.05 percent to about 4 percent of total volume or about 0.01 percent by weight of dry cement weight to about 4 percent by weight of dry cement.

The polymeric microspheres may be added to cementitious compositions in a number of forms. The first is as a dry powder, in which dry powder handling equipment for use with very low bulk density material can be used. The polymeric microspheres are available as a damp powder, which is 85% water by weight. Another form is as a liquid admixture such as a paste or slurry. In certain embodiments use of a paste or slurry substantially reduces the loss of material during the charging of the mixer. A third form is as a compact mass, such as a block or puck, similar to the DELVO® ESC admixture sold by Degussa Admixtures, Inc., Cleveland, Ohio. The polymeric microspheres may be preformed into discreet units with an adhesive that breaks down in water. Article size is designed to provide a convenient volume percent of voids in the cementitious composition.

The cementitious composition described herein may contain other additives or ingredients and should not be limited to the stated formulations. Cement additives that can be added include, but are not limited to: air entrainers, aggregates, pozzolans, dispersants, set and strength accelerators/enhancers, set retarders, water reducers, corrosion inhibitors, wetting agents, water soluble polymers, rheology modifying agents, water repellents, fibers, dampproofing admixtures, permeability reducers, pumping aids, fungicidal admixtures, germicidal admixtures, insecticide admixtures, finely divided mineral admixtures, alkali-reactivity reducer, bonding admixtures, shrinkage reducing admixtures, and any other admixture or additive that does not adversely affect the properties of the cementitious composition.

Aggregate can be included in the cementitious formulation to provide for mortars which include fine aggregate, and concretes which also include coarse aggregate. The fine aggregate are materials that almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed marble, glass spheres, granite, limestone, calcite, feldspar, alluvial sands, sands or any other durable aggregate, and mixtures thereof.

A pozzolan is a siliceous or aluminosiliceous material that possesses little or no cementitious value but will, in the presence of water and in finely divided form, chemically react with the calcium hydroxide produced during the hydration of portland cement to form materials with cementitious properties. Diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Natural pozzolan is a term of art used to define the pozzolans that occur in nature, such as volcanic tuffs, pumices, trasses, diatomaceous earths, opaline, cherts, and some shales. Nominally inert materials can also include finely divided raw quartz, dolomites, limestone, marble, granite, and others. Fly ash is defined in ASTM C618.

If used, silica fume can be uncompacted or can be partially compacted or added as a slurry. Silica fume additionally reacts with the hydration byproducts of the cement binder, which provides for increased strength of the finished articles and decreases the permeability of the finished articles. The silica fume, or other pozzolans such as fly ash, slag or calcined clay such as metakaolin, can be added to the cementitious wet cast mixture in an amount from about 5% to about 70% based on the weight of the cementitious material.

A dispersant if used in the cementitious composition can be any suitable dispersant such as lignosulfonates, beta naphthalene sulfonates, sulfonated melamine formaldehyde condensates, polyaspartates, polycarboxylate dispersants with or without pendant polyether units, naphthalene sulfonate formaldehyde condensate resins for example LOMAR D® (Cognis Inc., Cincinnati, Ohio), or oligomeric dispersants.

Polycarboxylate dispersants can be used, by which is meant a dispersant having a carbon backbone with pendant side chains, wherein at least a portion of the side chains are attached to the backbone through a carboxyl group or an ether group. The term dispersant is also meant to include those chemicals that also function as a plasticizer, high range water reducer, fluidizer, antiflocculating agent, or superplasticizer for cementitious compositions. Examples of polycarboxylate dispersants can be found in U.S. Pub. No. 2002/0019459 A1, U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516; U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, and U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are all incorporated herein by reference.

The polycarboxylate dispersants used in the system can be at least one of the dispersant formulas a) through j):
a) a dispersant of Formula (I): 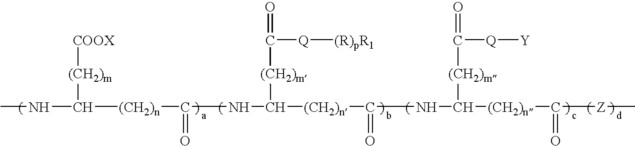
wherein in Formula (I)
   X is at least one of hydrogen, an alkali earth metal ion, an alkaline earth metal ion, ammonium ion, or amine;
   R is at least one of C₁ to C₆ alkyl(ene) ether or mixtures thereof or C₁ to C₆ alkyl(ene) imine or mixtures thereof;
   Q is at least one of oxygen, NH, or sulfur;
   p is a number from 1 to about 300 resulting in at least one of a linear side chain or branched side chain;
   R₁ is at least one of hydrogen, C₁ to C₂₀ hydrocarbon, or functionalized hydrocarbon containing at least one of —OH, —COOH, an ester or amide derivative of —COOH, sulfonic acid, an ester or amide derivative of sulfonic acid, amine, or epoxy;
   Y is at least one of hydrogen, an alkali earth metal ion, an alkaline earth metal ion, ammonium ion, amine, a hydrophobic hydrocarbon or polyalkylene oxide moiety that functions as a defoamer;
   m, m′, m″, n, n′, and n″ are each independently 0 or an integer between 1 and about 20;
   Z is a moiety containing at least one of i) at least one amine and one acid group, ii) two functional groups capable of incorporating into the backbone selected from the group consisting of dianhydrides, dialdehydes, and di-acid-chlorides, or iii) an imide residue; and
   wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero;
b) a dispersant of Formula (II): 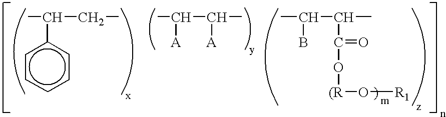
wherein in Formula (II):
   A is COOM or optionally in the “y” structure an acid anhydride group (—CO—O—CO—) is formed in place of the A groups between the carbon atoms to which the A groups are bonded to form an anhydride;
   B is COOM
   M is hydrogen, a transition metal cation, the residue of a hydrophobic polyalkylene glycol or polysiloxane, an alkali metal ion, an alkaline earth metal ion, ferrous ion, aluminum ion, (alkanol)ammonium ion, or (alkyl)ammonium ion;
   R is a C₂₋₆ alkylene radical;
   R1 is a C₁₋₂₀ alkyl, C₆₋₉ cycloalkyl, or phenyl group;
   x, y, and z are a number from 0.01 to 100;
   m is a number from 1 to 100; and
   n is a number from 10 to 100;
c) a dispersant comprising at least one polymer or a salt thereof having the form of a copolymer of
   i) a maleic anhydride half-ester with a compound of the formula RO(AO)ₘH, wherein R is a C₁-C₂₀ alkyl group, A is a C₂₋₄ alkylene group, and m is an integer from 2-16; and
   ii) a monomer having the formula CH₂═CHCH₂—(OA)ₙOR, wherein n is an integer from 1-90 and R is a C₁₋₂₀ alkyl group;
d) a dispersant obtained by copolymerizing 5 to 98% by weight of an (alkoxy)polyalkylene glycol mono(meth)acrylic ester monomer (a) represented by the following general formula (1): 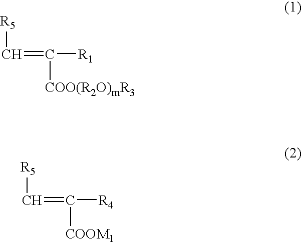
wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;
e) a graft polymer that is a polycarboxylic acid or a salt thereof, having side chains derived from at least one species selected from the group consisting of oligoalkyleneglycols, polyalcohols, polyoxyalkylene amines, and polyalkylene glycols;
f) a dispersant of Formula (III): 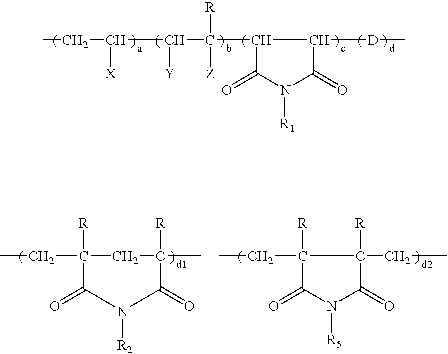
wherein in Formula (III):
   D=a component selected from the group consisting of the structure d1, the structure d2, and mixtures thereof;
   X=H, CH₃, C₂ to C₆ Alkyl, Phenyl, p-Methyl Phenyl, or Sulfonated Phenyl;
   Y=H or —COOM;
   R=H or CH₃;
   Z=H, —SO₃M, —PO₃M, —COOM, —O(CH₂)ₙOR₃ where n=2 to 6, —COOR₃, or —(CH₂)ₙOR₃ where n=0 to 6, —CONHR₃, —CONHC(CH₃)₂ CH₂SO₃M, —COO(CHR₄)ₙOH where n=2 to 6, or —O(CH₂)ₙOR₄ wherein n=2 to 6;
   R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
   R₄=H, Methyl, C₂ to about C₆ Alkyl, or about C₆ to about C₁₀ aryl;
   M=H, Alkali Metal, Alkaline Earth Metal, Ammonium, Amine, triethanol amine, Methyl, or C₂ to about C₆ Alkyl;
   a=0 to about 0.8;
   b=about 0.2 to about 1;
   c=0 to about 0.5;
   d=0 to about 0.5;
   wherein a, b, c, and d represent the mole fraction of each unit and the sum of a, b, c, and d is 1;
   wherein a can represent 2 or more differing components in the same dispersant structure;
   wherein b can represent 2 or more differing components in the same dispersant structure;
   wherein c can represent 2 or more differing components in the same dispersant structure; and
   wherein d can represent 2 or more differing components in the same dispersant structure;
g) a dispersant of Formula (IV): 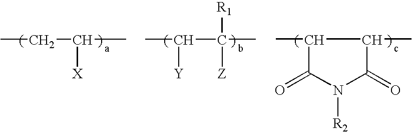
wherein in Formula (IV):
   the “b” structure is one of a carboxylic acid monomer, an ethylenically unsaturated monomer, or maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
   X=H, CH₃, C₂ to C₆ Alkyl, Phenyl, p-Methyl Phenyl, p-Ethyl Phenyl, Carboxylated Phenyl, or Sulfonated Phenyl;
   Y=H, —COOM, —COOH, or W;
   W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the polycarboxylate dispersant;
   Z=H, —COOM, —O(CH₂)ₙOR₃ where n=2 to 6, —COOR₃, —(CH₂)ₙOR₃ where n=0 to 6, or —CONHR₃;
   R₁=H, or CH₃;
   R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;
   R₄=H, Methyl, or C₂ to C₈ Alkyl;
   R₅=C₁ to C₁₈ alkyl or C₆ to C₁₈ alkyl aryl;
   M=Alkali Metal, Alkaline Earth Metal, Ammonia, Amine, monoethanol amine, diethanol amine, triethanol amine, morpholine, imidazole;
   a=0.01-0.8;
   b=0.2-0.99;
   c=0-0.5;
   wherein a, b, c represent the mole fraction of each unit and the sum of a, b, and c, is 1;
   wherein a can represent 2 or more differing components in the same dispersant structure; and
   wherein c can represent 2 or more differing components in the same dispersant structure;
h) a random copolymer corresponding to the following Formula (V) in free acid or salt form having the following monomer units and numbers of monomer units: 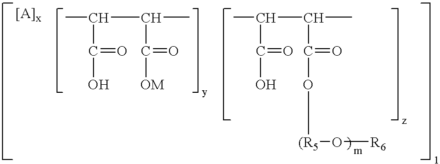
wherein A is selected from the moieties (i) or (ii)
   (i) —CR₁R₂—CR₃R₄— 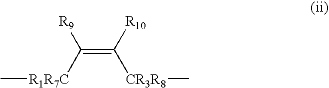
   wherein R₁ and R₃ are selected from substituted benzene, C₁₋₈ alkyl, C₂₋₈ alkenyl, C₂₋₈ alkylcarbonyl, C₁₋₈ alkoxy, carboxyl, hydrogen, and a ring, R₂ and R₄ are selected from the group consisting of hydrogen and C₁₋₄ alkyl, wherein R₁ and R₃ can together with R₂ and/or R₄ when R₂ and/or R₄ are C₁₋₄ alkyl form the ring;
   R₇, R₈, R₉, and R₁₀ are individually selected from the group consisting of hydrogen, C₁₋₆ alkyl, and a C₂₋₈ hydrocarbon chain, wherein R₁ and R₃ together with R₇ and/or R₈, R₉, and R₁₀ form the C₂₋₈ hydrocarbon chain joining the carbon atoms to which they are attached, the hydrocarbon chain optionally having at least one anionic group, wherein the at least one anionic group is optionally sulfonic;
   M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;
   R₅ is a C₂₋₈ alkylene radical;
   R₆ is selected from the group consisting of C₁₋₂₀ alkyl, C₆₋₉ cycloalkyl and phenyl;
   n, x, and z are numbers from 1 to 100;
   y is 0 to 100;
   m is 2 to 1000;
   the ratio of x to (y+z) is from 1:10 to 10:1 and the ratio of y:z is from 5:1 to 1:100;
i) a copolymer of oxyalkyleneglycol-alkenyl ethers and unsaturated mono and/or dicarboxylic acids, comprising:
   i) 0 to 90 mol % of at least one component of the formula 3a or 3b: 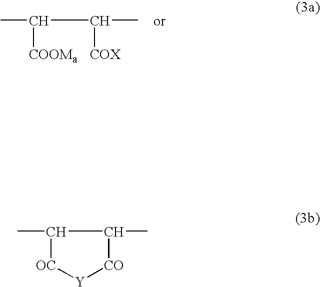
wherein M is a hydrogen atom, a mono- or divalent metal cation, an ammonium ion or an organic amine residue, a is 1, or when M is a divalent metal cation a is ½;
   wherein X is —OMₐ,
      —O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,
      —NHR₂, —N(R²)₂ or mixtures thereof in which R²=R¹ or —CO—NH₂; and
   wherein Y is an oxygen atom or —NR²;
   ii) 1 to 89 mol % of components of the general formula 4: 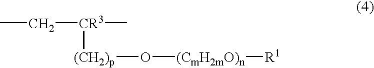
   wherein R₃ is a hydrogen atom or an aliphatic hydrocarbon radical containing from 1 to 5 carbon atoms, p is 0 to 3, and Ri is hydrogen, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulfonic substituted aryl radical containing 6 to 14 carbon atoms, m is independently 2 to 4, and n is 0 to 100, and
   iii) 0 to 10 mol % of at least one component of the formula 5a or 5b: 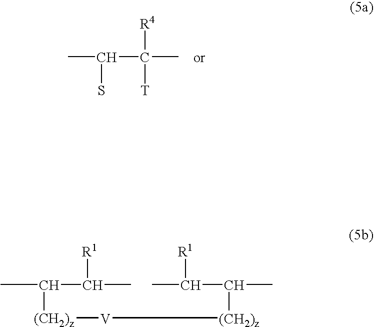
   wherein S is a hydrogen atom or —COOMₐ or —COOR₅, T is —COOR₅, —W—R₇, —CO—[—NH—(CH2)3)—]ₛ—W—R₇, —CO—O—(CH₂)_{z}—W—R₇, a radical of the general formula: 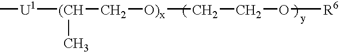
   or —(CH₂)_{z}—V—(CH₂)_{z}—CH═CH—R₁, or when S is —COOR₅ or —COOMₐ, U₁ is —CO—NHM—, —O— or —CH₂O, U₂ is —NH—CO—, —O— or —OCH₂, V is —O—CO—C₆H₄—CO—O— or —W—, and W is 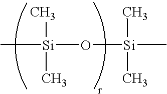
   R4 is a hydrogen atom or a methyl radical, R5 is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆=R₁ or 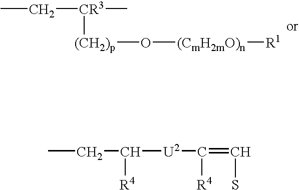
   R₇=R₁ or 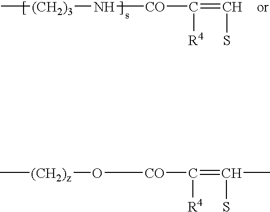
   r is 2 to 100, s is 1 or 2, x is 1 to 150, y is 0 to 15 and z is 0 to 4;
   iv) 0 to 90 mol % of at least one component of the formula 6a, 6b, or 6c: 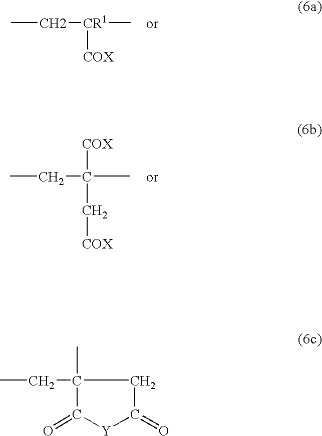
   wherein M is a hydrogen atom, a mono- or divalent metal cation, an ammonium ion or an organic amine residue, a is 1, or when M is a divalent metal cation a is ½;
   wherein X is —OMₐ,
      —O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,
      —NH—(CₘH₂ₘO)ₙ—R¹,
      —NHR₂, —N(R²)₂ or mixtures thereof in which R²=R¹ or —CO—NH₂; and
   wherein Y is an oxygen atom or —NR²;
j) a copolymer of dicarboxylic acid derivatives and oxyalkylene glycol-alkenyl ethers, comprising:
   i) 1 to 90 mol. % of at least one member selected from the group consisting of structural units of formula 7a and formula 7b: 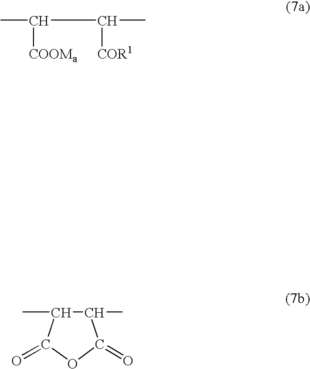
      wherein M is H, a monovalent metal cation, a divalent metal cation, an ammonium ion or an organic amine;
      a is ½ when M is a divalent metal cation or 1 when M is a monovalent metal cation;
      wherein R¹ is —OMₐ, or
         —O—(CₘH₂ₘO)ₙ—R² wherein R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of —COOMₐ, —(SO₃)Mₐ, and —(PO₃)Mₐ₂;
      m is 2 to 4;
      n is 1 to 200;
   ii) 0.5 to 80 mol. % of the structural units of formula 8: 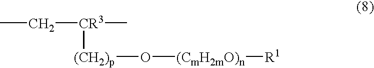
      wherein R³ is H or a C₁₋₅ aliphatic hydrocarbon;
      p is 0 to 3;
      R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of —COOMₐ, —(SO₃)Mₐ, and —(PO₃) Mₐ₂;
      m is 2 to 4;
      n is 1 to 200;
   iii) 0.5 to 80 mol. % structural units selected from the group consisting of formula 9a and formula 9b: 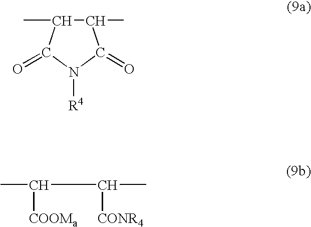
      wherein R⁴ is H, C₁₋₂₀ aliphatic hydrocarbon that is optionally substituted with at least one hydroxyl group, —(CₘH₂ₘO)ₙ—R², —CO—NH—R², C₅₋₈ cycloaliphatic hydrocarbon, or a C₆₋₁₄ aryl that is optionally substituted with at least one member selected from the group consisting of —COOMₐ, —(SO₃)Mₐ, and —(PO₃)Mₐ₂;
      M is H, a monovalent metal cation, a divalent metal cation, an ammonium ion or an organic amine;
      a is ½ when M is a divalent metal cation or 1 when M is a monovalent metal cation;
      R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of —COOMₐ, —(SO₃)Mₐ, and —(PO₃)Mₐ₂;
      m is 2 to 4;
      n is 1 to 200;
   iv) 1 to 90 mol. % of structural units of formula 10 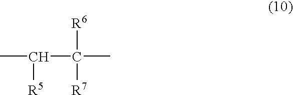
      wherein R⁵ is methyl, or methylene group, wherein R⁵ forms one or more 5 to 8 membered rings with R⁷;
      R⁶ is H, methyl, or ethyl;
      R⁷ is H, a C₁₋₂₀ aliphatic hydrocarbon, a C₆₋₁₄ aryl that is optionally substituted with at least one member selected from the group consisting of —COOMₐ, —(SO₃)Mₐ, and —(PO₃)Mₐ₂, a C₅₋₈ cycloaliphatic hydrocarbon, —OCOR⁴, —OR⁴, and —COOR⁴, wherein R⁴ is H, a C₁₋₂₀ aliphatic hydrocarbon that is optionally substituted with at least one —OH, —(CₘH₂ₘO)ₙ—R², —CO—NH—R², C₅₋₈ cycloaliphatic hydrocarbon, or a C₆₋₁₄ aryl residue that is optionally substituted with a member selected from the group consisting of —COOMₐ, —(SO₃)Mₐ, and —(PO₃)Mₐ₂;

In formula (e) the word “derived” does not refer to derivatives in general, but rather to any polycarboxylic acid/salt side chain derivatives of oligoalkyleneglycols, polyalcohols and polyalkylene glycols that are compatible with dispersant properties and do not destroy the graft polymer.

The substituents in the optionally substituted aryl radical of formula (i), containing 6 to 14 carbon atoms, may be hydroxyl, carboxyl, C₁₋₁₄ alkyl, or sulfonate groups.

The substituents in the substituted benzene may be hydroxyl, carboxyl, C₁₋₁₄ alkyl, or sulfonate groups.

The term oligomeric dispersant refers to oligomers that are a reaction product of:

(k) component A, optionally component B, and component C; wherein each component A is independently a nonpolymeric, functional moiety that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof; wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, or mixtures thereof, that are disclosed in U.S. Pat. No. 6,133,347, U.S. Pat. No. 6,492,461, and U.S. Pat. No. 6,451,881, which are hereby incorporated by reference.

Set and strength accelerators/enhancers that can be used include, but are not limited to, a nitrate salt of an alkali metal, alkaline earth metal, or aluminum; a nitrite salt of an alkali metal, alkaline earth metal, or aluminum; a thiocyanate of an alkali metal, alkaline earth metal or aluminum; an alkanolamine; a thiosulphate of an alkali metal, alkaline earth metal, or aluminum; a hydroxide of an alkali metal, alkaline earth metal, or aluminum; a carboxylic acid salt of an alkali metal, alkaline earth metal, or aluminum (preferably calcium formate); a polyhydroxylalkylamine; a halide salt of an alkali metal or alkaline earth metal (preferably bromide), Examples of accelerators that can be used include, but are not limited to, POZZOLITH® NC534, non chloride type accelerator and/or RHEOCRETE® CNI calcium nitrite-based corrosion inhibitor both sold under the trademarks by Degussa Admixtures Inc. of Cleveland, Ohio.

The salts of nitric acid have the general formula M(NO₃)ₐ where M is an alkali metal, or an alkaline earth metal or aluminum, and where a is 1 for alkali metal salts, 2 for alkaline earth salts, and 3 for aluminum salts. Preferred are nitric acid salts of Na, K, Mg, Ca and Al.

Nitrite salts have the general formula M(NO₂)ₐ where M is an alkali metal, or an alkaline earth metal or aluminum, and where a is 1 for alkali metal salts, 2 for alkaline earth salts, and 3 for aluminum salts. Preferred are nitric acid salts of Na, K, Mg, Ca and Al.

The salts of the thiocyanic acid have the general formula M(SCN)_{b}, where M is an alkali metal, or an alkaline earth metal or aluminum, and where b is 1 for alkali metal salts, 2 for alkaline earth salts and 3 for aluminum salts. These salts are variously known as sulfocyanates, sulfocyanides, rhodanates or rhodanide salts. Preferred are thiocyanic acid salts of Na, K, Mg, Ca and Al.

Alkanolamine is a generic term for a group of compounds in which trivalent nitrogen is attached directly to a carbon atom of an alkyl alcohol. A representative formula is N[H]_{c}[(CH₂)_{d}CHRCH₂R]ₑ, where R is independently H or OH, c is 3-e, d is 0 to about 4 and e is 1 to about 3. Examples include, but are not limited to, monoethanoalamine, diethanolamine, triethanolamine, and triisopropanolamine.

The thiosulfate salts have the general formula M_{f}(S₂O₃)_{g} where M is alkali metal or an alkaline earth metal or aluminum, and f is 1 or 2 and g is 1, 2 or 3, depending on the valencies of the M metal elements. Preferred are thiosulfate acid salts of Na, K, Mg, Ca and Al.

The carboxylic acid salts have the general formula RCOOM wherein R is H or C₁ to about C₁₀ alkyl, and M is alkali metal or an alkaline earth metal or aluminum. Preferred are carboxylic acid salts of Na, K, Mg, Ca and Al. An example of carboxylic acid salt is calcium formate.

A polyhydroxylalkylamine can have the general formula 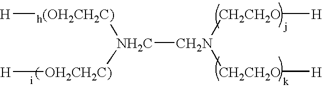
wherein h is 1 to 3, i is 1 to 3, j is 1 to 3, and k is 0 to 3. A preferred polyhydroxyalkylamine is tetrahydroxyethylethylenediamine.

Set retarding, or also known as delayed-setting or hydration control, admixtures are used to retard, delay, or slow the rate of setting of cementitious compositions. They can be added to the cementitious composition upon initial batching or sometime after the hydration process has begun. Set retarders are used to offset the accelerating effect of hot weather on the setting of cementitious compositions, or delay the initial set of concrete or grout when difficult conditions of placement occur, or problems of delivery to the job site, or to allow time for special finishing processes. Most set retarders also act as low level water reducers and can also be used to entrain some air into cementitious compositions. Lignosulfonates, hydroxylated carboxylic acids, borax, gluconic, tartaric and other organic acids and their corresponding salts, phosphonates, certain carbohydrates such as sugars, polysaccharides and sugar-acids and mixtures thereof can be used as retarding admixtures.

Corrosion inhibitors in cementitious compositions serve to protect embedded reinforcing steel from corrosion. The high alkaline nature of the cementitious composition causes a passive and non-corroding protective oxide film to form on the steel. However, carbonation or the presence of chloride ions from deicers or seawater, together with oxygen can destroy or penetrate the film and result in corrosion. Corrosion-inhibiting admixtures chemically slow this corrosion reaction. The materials most commonly used to inhibit corrosion are calcium nitrite, sodium nitrite, sodium benzoate, certain phosphates or fluorosilicates, fluoroaluminates, amines, organic based water repelling agents, and related chemicals.

In the construction field, many methods of protecting cementitious compositions from tensile stresses and subsequent cracking have been developed through the years. One modern method involves distributing fibers throughout a fresh cementitious mixture. Upon hardening, this cementitious composition is referred to as fiber-reinforced cementitious composition. Fibers can be made of zirconium materials, carbon, steel, fiberglass, or synthetic materials, e.g., polypropylene, nylon, polyethylene, polyester, rayon, high-strength aramid, or mixtures thereof.

Dampproofing admixtures reduce the permeability of cementitious compositions that have low cement contents, high water-cement ratios, or a deficiency of fines in the aggregate portion. These admixtures retard moisture penetration into wet cementitious compositions and include certain soaps, stearates, and petroleum products.

Permeability reducers are used to reduce the rate at which water under pressure is transmitted through cementitious compositions. Silica fume, fly ash, ground slag, metakaolin, natural pozzolans, water reducers, and latex can be employed to decrease the permeability of the cementitious composition.

Pumping aids are added to cementitious compositions to improve pumpability. These admixtures thicken the fluid cementitious compositions, i.e., increasing viscosity, to reduce de-watering of the paste while it is under pressure from the pump. Among the materials used as pumping aids in cementitious compositions are organic and synthetic polymers, hydroxyethylcellulose (HEC) or HEC blended with dispersants, polysaccharides organic flocculents, organic emulsions of paraffin, coal tar, asphalt, acrylics, bentonite and pyrogenic silicas, nano-silicas, natural pozzolans, fly ash and hydrated lime.

Bacteria and fungal growth on or in hardened cementitious compositions may be partially controlled through the use of fungicidal, germicidal, and insecticidal admixtures. The most effective materials for these purposes are polyhalogenated phenols, dialdrin emulsions, and copper compounds.

Coloring admixtures are usually composed of pigments, either organic such as phthalocyanine or inorganic pigments such as metal-containing pigments that comprise, but are not limited to metal oxides and others, and can include, but are not limited to, iron oxide containing pigments such as CHROMIX®L (Degussa Admixtures Inc., Cleveland, Ohio), chromium oxide, aluminum oxide, lead chromate, titanium oxide, zinc white, zinc oxide, zinc sulfide, lead white, iron manganese black, cobalt green, manganese blue, manganese violet, cadmium sulfoselenide, chromium orange, nickel titanium yellow, chromium titanium yellow, cadmium sulfide, zinc yellow, ultramarine blue and cobalt blue.

Alkali-reactivity reducers can reduce the alkali-aggregate reaction and limit the disruptive expansion forces that this reaction can produce in hardened cementitious compositions. Pozzolans (fly ash, silica fume), blast-furnace slag, salts of lithium and barium are especially effective.

The shrinkage reducing agent which can be used comprises but is not limited to RO(AO)₁₋₁₀H, wherein R is a C₁₋₅ alkyl or C₅₋₆ cycloalkyl radical and A is a C₂₋₃ alkylene radical, alkali metal sulfate, alkaline earth metal sulfates, alkaline earth oxides, preferably sodium sulfate and calcium oxide. TETRAGUARD® admixture is an example of a shrinkage reducing agent (available from Degussa Admixtures, Inc. of Cleveland, Ohio) that can be used.

Examples of the previously described embodiments were tested for their effect on Freeze-Thaw (F/T) durability. The concrete samples in Tables 1-3 were prepared by adding water to a rotary drum mixer, followed by coarse aggregate and cement. The microspheres were then added on top of these materials, followed by sand. The drum mixer was then turned on. If a conventional air entraining agent (AEA) was used, it was added on top of the sand. Additional water was added during mixing to achieve the desired amount of slump. The mixing speed was about 20 rpm for 5 minutes. After 5 minutes, the mixer was stopped. The slump and air were measured and the specimens cast.

Relevant ASTM testing procedures are: Petrographic examination (ASTM C 457)2, Freeze thaw testing (ASTM C 666—Procedure A)—[greater than 60 is considered acceptable], Salt scaling testing (ASTM C 672)—[0=best, 5=worst], Compressive strength measurements (ASTM C 39).

The samples in Table 1 were prepared to determine the ability of 0.4-1 μm average diameter microspheres to provide freeze-thaw protection to concrete. The microspheres were added as a liquid dispersion, 30% by weight.

TABLE 1

| | Sample | | | | | | | | |
|---|---|---|---|---|---|---|---|---|---|
| | 1 | 2 | 3 | 4 | 5 | 6 | 7 | 8 | 9 |
| Cement (lbs/yd³) | 557 | 565 | 562 | 558 | 544 | 564 | 558 | 552 | 531 |
| Sand (lbs/yd³) | 1153 | 1250 | 1245 | 1235 | 1204 | 1249 | 1236 | 1223 | 1176 |
| Stone (lbs/yd³) | 1611 | 1747 | 1739 | 1725 | 1683 | 1745 | 1727 | 1709 | 1643 |
| Water (lbs/yd³) | 311 | 315 | 314 | 311 | 304 | 315 | 312 | 309 | 297 |
| W/C Ratio | 0.559 | 0.559 | 0.559 | 0.559 | 0.559 | 0.559 | 0.559 | 0.559 | 0.559 |
| Sand/Aggregate | 0.42 | 0.42 | 0.42 | 0.42 | 0.42 | 0.42 | 0.42 | 0.42 | 0.42 |
| AEA (oz/cwt) | 7.42 | — | — | — | — | — | — | — | — |
| Microspheres, 0.4 μm (% by volume) | — | .01 | .05 | .1 | .5 | — | — | — | — |
| Microspheres, 1 μm (% by volume) | — | — | — | — | — | .01 | .05 | .1 | .5 |
| Slump (in) 5 minutes | 7.75 | 7.00 | 7.75 | 7.25 | 8.25 | 7.25 | 7.00 | 7.50 | 8.75 |
| Air (%) (Volumetric) 5 minutes | 7.6 | 1.9 | 2.3 | 3.1 | 5.5 | 2.0 | 3.0 | 4.0 | 7.7 |
| Compressive Strength (psi) | | | | | | | | | |
| 7 day | 2610 | 3940 | 3770 | 3600 | 2890 | 4030 | 3570 | 3350 | 2200 |
| 28 day | 3490 | 5190 | 4920 | 4720 | 3650 | 4970 | 4710 | 4440 | 3150 |
| Freeze-Thaw Testing Durability Factor | 99 | fail | 64 | 99 | 99 | fail | 97 | 93 | 99 |
| (180 cycles) | | | | | | | | | |
| Visual Scaling (FT Beams) | 2 | — | 3 | 3 | 2 | — | 3 | 4 | 2 |

AEA = Air Entraining Agent
W/C Ratio = water to cement ratio

Table 1 demonstrates that additions of at least 0.05% by volume of 0.4-1 μm average diameter microspheres (samples 4, 5, 7, 8, and 9) provide freeze/thaw protection to cementitious compositions similar to a conventional air-entrained control (sample 1).

The samples in Table 2 were prepared to determine the ability of 0.4-1 μm average diameter microspheres to provide freeze-thaw protection to concrete when added as a dry dispersion. The 0.4 μm and 1 μm average diameter microspheres were added to the cementitious composition as a dry powder.

TABLE 2

| | Sample | | | | | | | | |
|---|---|---|---|---|---|---|---|---|---|
| | 10 | 11 | 12 | 13 | 14 | 15 | 16 | 17 | 18 |
| Cement (lbs/yd³) | 569 | 566 | 566 | 565 | 562 | 565 | 566 | 563 | 552 |
| Sand (lbs/yd³) | 1201 | 1278 | 1278 | 1276 | 1270 | 1276 | 1278 | 1273 | 1248 |
| Stone (lbs/yd³) | 1652 | 1758 | 1758 | 1756 | 1747 | 1756 | 1758 | 1751 | 1717 |
| Water (lbs/yd³) | 313 | 311 | 311 | 311 | 309 | 311 | 311 | 310 | 304 |
| W/C Ratio | 0.550 | 0.550 | 0.550 | 0.550 | 0.550 | 0.550 | 0.550 | 0.550 | 0.550 |
| Sand/Aggregate | 0.42 | 0.42 | 0.42 | 0.42 | 0.42 | 0.42 | 0.42 | 0.42 | 0.42 |
| AEA (oz/cwt) | 9.3 | — | — | — | — | — | — | — | — |
| Microspheres, 0.4 μm (% by volume) | — | .01 | .05 | .1 | .5 | — | — | — | — |
| Microspheres, 1 μm (% by volume) | — | — | — | — | — | .01 | .05 | .1 | .5 |
| Slump (in) 5 minutes | 6.75 | 6.00 | 5.50 | 5.00 | 5.25 | 6.25 | 6.00 | 6.00 | 6.50 |
| Air (%) (Volumetric) 5 minutes | 5.7 | 1.7 | 1.7 | 1.8 | 2.3 | 1.8 | 1.7 | 2.1 | 4.0 |
| Compressive Strength (psi) | | | | | | | | | |
| 7 day | 2740 | 4220 | 4210 | 4120 | 4040 | 4360 | 4030 | 4040 | 3620 |
| 28 day | 3990 | 5610 | 5540 | 5380 | 5380 | 5580 | 5260 | 5290 | 4560 |
| Freeze-Thaw Testing Durability Factor | 97 | fail | fail | fail | 92 | fail | fail | fail | 97 |
| (180 cycles) | | | | | | | | | |
| Visual Scaling (FT Beams) | 3 | — | — | — | 3 | — | — | — | 3 |

AEA = Air Entraining Agent
W/C Ratio = water to cement ratio

Samples 14 and 18 in Table 2 demonstrate that 0.4 μm average diameter microspheres (sample 14) and 1 μm average diameter microspheres (sample 18) provide freeze/thaw protection when added as a dry powder at levels of 0.5% by volume. Both samples (14 and 18) had similar freeze-thaw damage resistance (sample 14-92 and sample 18-97) as the control sample 10 (97) which contained air entraining agent and no microspheres.

The samples in Table 3 were prepared to determine the ability of 5 μm average diameter microspheres to provide freeze-thaw protection to concrete when added as a dry dispersion. The 5 μm average diameter microspheres were added to the cementitious composition as a dry powder.

TABLE 3

| | Sample | | |
|---|---|---|---|
| | 19 | 20 | 21 |
| Cement (lbs/yd³) | 559 | 548 | 539 |
| Sand (lbs/yd³) | 1124 | 1179 | 1160 |
| Stone (lbs/yd³) | 1680 | 1762 | 1733 |
| Water (lbs/yd³) | 334 | 328 | 322 |
| W/C Ratio | 0.598 | 0.598 | 0.598 |
| Sand/Aggregate | 0.42 | 0.42 | 0.42 |
| AEA (oz/cwt) | 9.3 | — | — |
| Microspheres, 5 μm (% by volume) | — | 1.0 | 2.0 |
| Slump (in) 5 minutes | 7.50 | 7.50 | 5.25 |
| Air (%) (Volumetric) 5 minutes | 5.7 | 3.2 | 4.8 |
| Compressive Strength (psi) | | | |
| 7 day | 2340 | 3120 | 2750 |
| 28 day | 3250 | 3880 | 3500 |
| Freeze-Thaw Testing | 97 | 96 | 96 |
| Durability Factor (180 cycles) | | | |
| Visual Scaling (FT Beams) | 1 | 1 | 1 |

AEA = Air Entraining Agent
W/C Ratio = water to cement ratio

Table 3 demonstrates that addition of at least 1% 5 μm average diameter microspheres to a cementitious composition (sample 20) provides freeze/thaw durability (sample 20-96) similar to a conventionally air-entrained control (sample 19-97).

In one embodiment the cementitious freeze-thaw damage resistant wet cast composition comprises hydraulic cement and polymeric microspheres, wherein the polymeric microspheres have an average diameter of about 0.1 μm to less than about 10 μm, and the polymeric microspheres are liquid filled. The polymeric microspheres may comprise at least one of polyethylene, polypropylene, polymethyl methacrylate, poly-o-chlorostyrene, polyvinyl chloride, polyvinylidene chloride, polyacrylonitrile, polymethacrylonitrile, polystyrene, copolymers, or mixtures thereof; for example but not for limitation such as copolymers of vinylidene chloride-acrylonitrile, polyacrylonitrile-copolymethacrylonitrile, polyvinylidene chloride-copolyacrylonitrile, vinyl chloride-vinylidene chloride or mixtures thereof.

In another embodiment the cementitious wet cast composition contains the polymeric microspheres in a range from about 0.05 percent to 4 percent of total volume or about 1 percent to about 4 percent by weight of dry cement.

In certain embodiments the cementitious wet cast compositions described above further comprise at least one of air entrainers, aggregates, pozzolans, dispersants, set and strength accelerators/enhancers, set retarders, water reducers, corrosion inhibitors, wetting agents, water soluble polymers, rheology modifying agents, water repellents, fibers, dampproofing admixtures, permeability reducers, pumping aids, fungicidal admixtures, germicidal admixtures, insecticide admixtures, finely divided mineral admixtures, alkali-reactivity reducer, bonding admixtures, shrinkage reducing admixtures or mixtures thereof.

In another embodiment a method for preparing a freeze-thaw damage resistant wet cast cementitious composition from the compositions described above is provided that comprises providing a mixture of hydraulic cement and polymeric microspheres; wherein the polymeric microspheres have an average diameter of about 0.1 μm to about 10 μm. In certain embodiments the polymeric microspheres are added as at least one of a compact mass, damp powder, slurry or paste.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A cementitious freeze-thaw damage resistant wet cast composition comprising hydraulic cement and polymeric microspheres, wherein the polymeric microspheres have an average diameter of about 0.1 μm to less than about 10 μm, and the polymeric microspheres are liquid filled.

2. The cementitious wet cast composition of claim 1 wherein the polymeric microspheres comprise a polymer that is at least one of polyethylene, polypropylene, polymethyl methacrylate, poly-o-chlorostyrene, polyvinyl chloride, polyvinylidene chloride, polyacrylonitrile, polymethacrylonitrile, polystyrene, or copolymers or mixtures thereof.

3. The cementitious wet cast composition of claim 1 wherein the polymeric microspheres comprise at least one copolymer of vinylidene chloride-acrylonitrile, polyvinylidene chloride-copolyacrylonitrile, polyacrylonitrile-copolymethacrylonitrile, vinyl chloride-vinylidene chloride or mixtures thereof.

4. The cementitious wet cast composition of claim 1 wherein the polymeric microspheres are present in a range from about 0.01% to about 4% by weight of dry cement.

5. The cementitious wet cast composition of claim 1 wherein the polymeric microspheres are present in a range from about 0.05% to about 4% of total volume.

6. The cementitious wet cast composition of claim 1 wherein the volume of voids is about 4 volume percent or less.

7. The cementitious wet cast composition of claim 1 further comprising at least one of air entrainers, aggregates, pozzolans, dispersants, set and strength accelerators/enhancers, set retarders, air-entraining or air detraining agents, water reducers, corrosion inhibitors, wetting agents, water soluble polymers, rheology modifying agents, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures or mixtures thereof.

8. The cementitious wet cast composition of claim 7 wherein the dispersant is at least one of lignosulfonates, beta naphthalene sulfonates, sulfonated melamine formaldehyde condensates, polyaspartates, naphthalene sulfonate formaldehyde condensate resins, oligomers, polycarboxylates or mixtures thereof.

9. The cementitious wet cast composition of claim 7 wherein the set and strength accelerator/enhancer is at least one of:
a) a nitric acid salt of an alkali metal, alkaline earth metal, or aluminum;
b) a nitrite salt of an alkali metal, alkaline earth metal, or aluminum;
c) a thiocyanic acid salt of an alkali metal, alkaline earth metal or aluminum;
d) an alkanolamine;
e) a thiosulfate of an alkali metal, alkaline earth metal, or aluminum;
f) a carboxylic acid salt of an alkali metal, alkaline earth metal, or aluminum;
g) a polyhydroxylalkylamine; or
h) a halide salt of an alkali metal, alkaline earth metal, or aluminum.

10. A method for preparing a freeze-thaw damage resistant wet cast cementitious composition comprising forming a mixture of water, hydraulic cement, and polymeric microspheres, wherein the polymeric microspheres have an average diameter of about 0.1 μm to less than about 10 μm, and the polymeric microspheres are liquid filled.

11. The method of claim 10 wherein the polymeric microspheres comprise a polymer that is at least one of polyethylene, polypropylene, polymethyl methacrylate, poly-o-chlorostyrene, polyvinyl chloride, polyvinylidene chloride, polyacrylonitrile, polymethacrylonitrile, polystyrene or copolymers or mixtures thereof.

12. The method of claim 10 wherein the polymeric microspheres comprise at least one copolymer of vinylidene chloride-acrylonitrile, polyvinylidene chloride-copolyacrylonitrile, polyacrylonitrile-copolymethacrylonitrile, vinyl chloride-vinylidene chloride or mixtures thereof.

13. The method of claim 10 wherein the polymeric microspheres are present in a range from about 0.01% to about 4% by weight of dry cement.

14. The method of claim 10 wherein the polymeric microspheres are present in a range from about 0.05% to about 4% of total volume.

15. The method of claim 10 further comprising including in the wet cast cementitious composition at least one of air entrainers, aggregates, pozzolans, dispersants, set and strength accelerators/enhancers, set retarders, air-entraining or air detraining agents, water reducers, corrosion inhibitors, wetting agents, water soluble polymers, rheology modifying agents, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures or mixtures thereof.

16. The method of claim 15 wherein the dispersant is at least one of lignosulfonates, beta naphthalene sulfonates, sulfonated melamine formaldehyde condensates, polyaspartates, naphthalene sulfonate formaldehyde condensate resins, oligomers, polycarboxylates or mixtures thereof.

17. The method of claim 15 wherein the set and strength accelerator/enhancer is at least one of:
a) a nitric acid salt of an alkali metal, alkaline earth metal, or aluminum;
b) a nitrite salt of an alkali metal, alkaline earth metal, or aluminum;
c) a thiocyanic acid salt of an alkali metal, alkaline earth metal or aluminum;
d) an alkanolamine;
e) a thiosulfate of an alkali metal, alkaline earth metal, or aluminum;
f) a carboxylic acid salt of an alkali metal, alkaline earth metal, or aluminum;
g) a polyhydroxylalkylamine; or
h) a halide salt of an alkali metal, alkaline earth metal, or aluminum.

18. The method of claim 10, wherein the polymeric microspheres are added to the mixture in at least one of the following forms:
a. compact mass; or
b. powder.

19. The method of claim 10, wherein the polymeric microspheres are added to the mixture as a liquid admixture.

20. The method of claim 19, wherein the liquid admixture is at least one of a slurry or paste.
